(19) United States
(12) Patent Application Publication
(10) Pub. No.: US 2021/0076663 A1
(43) Pub. Date: Mar. 18, 2021

(54) VERMIN TRAP

(71) Applicant: Philip Chisholm, Halifax (CA)

(72) Inventor: Philip Chisholm, Halifax (CA)

(21) Appl. No.: 16/572,718

(22) Filed: Sep. 17, 2019

(51) Int. Cl. A01M 23/30; A01M 31/00; A01M 23/38; A01M 23/16

(52) U.S. Cl. CPC A01M 23/30; A01M 23/16; A01M 23/38; A01M 31/002

(57) ABSTRACT

Conventional mouse traps include a spring biased arm temporarily held open by a hold down bar, which is dislodged when a mouse releases a catch. Accordingly, a more robust vermin trap comprises: a housing; a catcher pivotally mounted on the housing, configured to be held in a set position and forced into a sprung position for trapping the vermin, and a latch. The latch comprising: an actuator, and a latching lever spring biased into the sprung position, and configured to be rotated closed in the set position. A striker mechanism is connected to the catcher for engaging the latching lever in the set position and disengaged from the latching lever in the sprung position, for moving the catcher from the set position to the sprung position. A trigger activates the actuator, thereby releasing the latching lever, and disengaging the striker mechanism from the latch, enabling the catcher to move to the sprung position to trap the vermin.

### TECHNICAL FIELD

The present invention relates to a vermin trap, and in particular to a release mechanism for a vermin trap that provides controllable and repeatable operation.

### BACKGROUND

Conventional mouse traps include a spring biased arm temporarily held open by a hold down bar, which is dislodged when a mouse releases a catch, typically covered in bait. Conventional traps are inexpensive and disposable, but are difficult to set and do not provide fine control over setting, release or resetting.

Some prior art references, such as U.S. Pat. No. 9,258,990 issued Feb. 16, 2016 to Harvey et al, and U.S. Pat. No. 5,107,619 issued Apr. 28, 1992 in the name of Zapata et al, disclose the use of a solenoid actuator to directly open and close the jaws of a mouse trap. Unfortunately, since the solenoids in the prior art references are directly activating the jaws, they need to be very strong, they require a lot of power, and therefore they are very expensive and bulky.

An object of the present invention is to overcome the shortcomings of the prior art by providing a vermin trap, that includes a robust release mechanism, requiring minimal power and expense that can be activate, set and reset remotely.

### SUMMARY OF THE INVENTION

Accordingly, the present invention relates to a vermin trap comprising:

a housing;

a catcher pivotally mounted on the housing, configured to be held in a set position and forced into a sprung position for trapping the vermin;

a latch comprising: a base; an actuator moveable on the base; and a latching lever pivotally mounted on the base about a latch axis spring biased into the sprung position and held in the set position by the actuator;

a striker mounted on the housing and connected to the catcher, and including a striker bar configured to be engaged by the latching lever in the set position and disengaged from the latching lever in the sprung position, for moving the catcher from the set position to the sprung position; and

a trigger configured to activate the actuator, thereby releasing the latching lever, and disengaging the striker bar from the latching lever, enabling the catcher to move to the sprung position to trap the vermin.

### BRIEF DESCRIPTION OF THE DRAWINGS

The invention will be described in greater detail with reference to the accompanying drawings which represent preferred embodiments thereof, wherein:

FIG. 1 is an isometric side view of a vermin trap device in accordance with an embodiment of the present invention;

FIG. 2 is an isometric side view of the device of FIG. 1 with the bait door open;

FIG. 3 is an isometric end view of the device of FIG. 1 in the set position;

FIG. 4 is an isometric end view of the device of FIG. 1 in the sprung position;

FIG. 5 is an isometric side view of the device of FIG. 1 in the sprung position;

FIG. 6 is an isometric side view of a latch of the device of FIG. 1 in the sprung position;

FIG. 7 is a side view of a latch of the device of FIG. 1 in the set position;

FIG. 8 is an isometric side view of a latch of the device of FIG. 1 in the set position including a force applicator;

FIG. 9 is an isometric side view of a latch of the device of FIG. 1 in the sprung position including a force applicator;

FIG. 10 is an isometric side view of an alternative latch of the device of FIG. 1 in the sprung position including a force applicator;

FIG. 11 is an isometric side view of the alternative latch of FIG. 10 in the set position;

FIG. 12A is an isometric view of the alternative latch of the device of FIG. 1 in the sprung position including a solenoid actuator;

FIG. 12B is an isometric side view of the alternative latch of FIG. 12A in the set position;

FIG. 13A is an isometric view of the alternative latch of the device of FIG. 1 in the sprung position including a servo-motor actuator;

FIG. 13B is an isometric side view of the alternative latch of FIG. 13B in the set position;

FIG. 14 is an isometric view of another embodiment of a vermin trap device of the present invention;

FIG. 15 is an isometric view of the embodiment of FIG. 14 in the sprung position;

FIG. 16 is an isometric view of the embodiment of FIG. 14 in the reset position;

FIG. 17 is an isometric view of the embodiment of FIG. 14 in the set position;

FIG. 18 is an isometric view of the embodiment of FIG. 14 in the set position;

FIG. 19 is an isometric view of another embodiment of a vermin trap device of the present invention in the set position;

FIG. 20 is an isometric view of the embodiment of FIG. 19 in the sprung position;

FIG. 21 is an isometric view of the embodiment of FIG. 19 in the sprung position;

FIG. 22 is an isometric view of another embodiment of a vermin trap device of the present invention;

FIG. 23 is an isometric view of the embodiment of FIG. 22 with the housing removed in the sprung position;

FIG. 24 is an isometric view of the embodiment of FIG. 22 with the housing removed in the sprung position;

FIG. 25 is an isometric view of the embodiment of FIG. 22 with the housing removed in the sprung position;

FIG. 26 is an isometric view of the embodiment of FIG. 22 with the housing removed in the sprung position;

FIG. 27 is an isometric view of the embodiment of FIG. 22 with the housing removed in the resetting position;

FIG. 28 is an isometric view of the embodiment of FIG. 22 with the housing removed in the set position;

FIG. 29 is an isometric view of an alternative snare for the embodiment of FIG. 22; and

FIG. 30 is a schematic diagram of a network of vermin traps controlled by a user controller.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

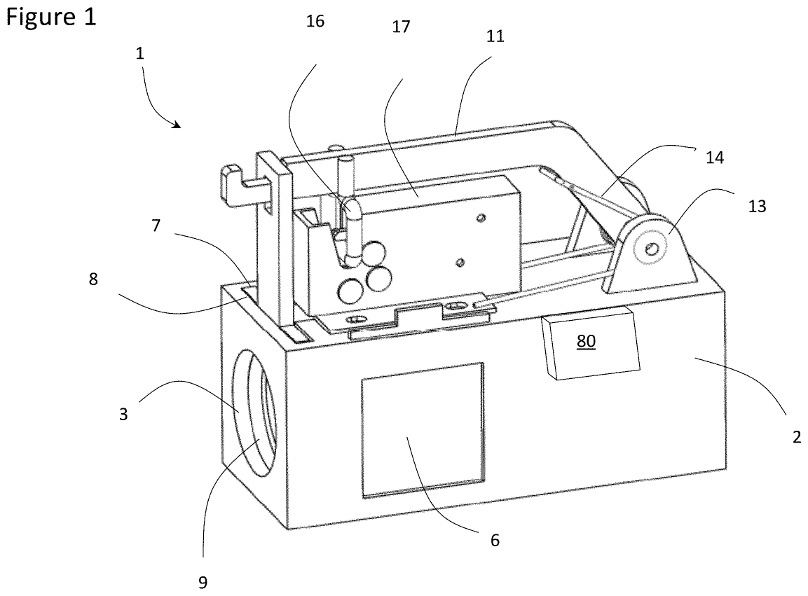

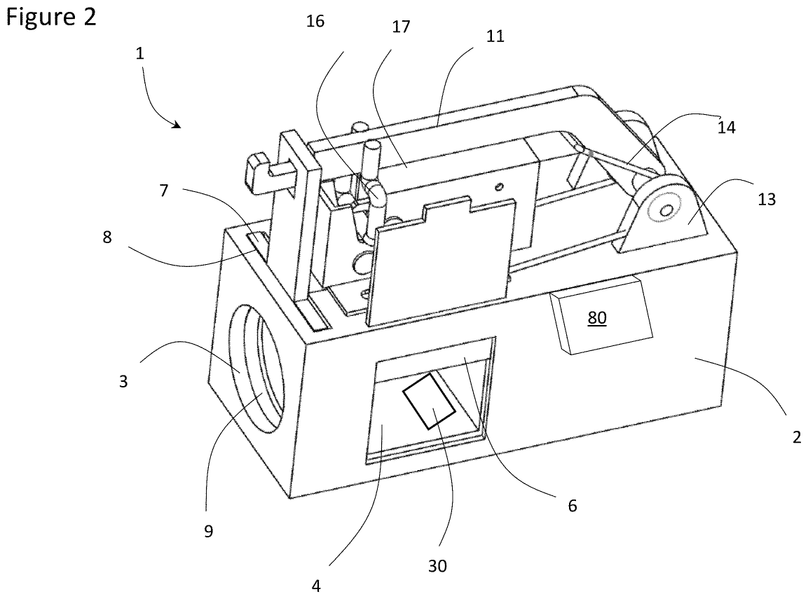

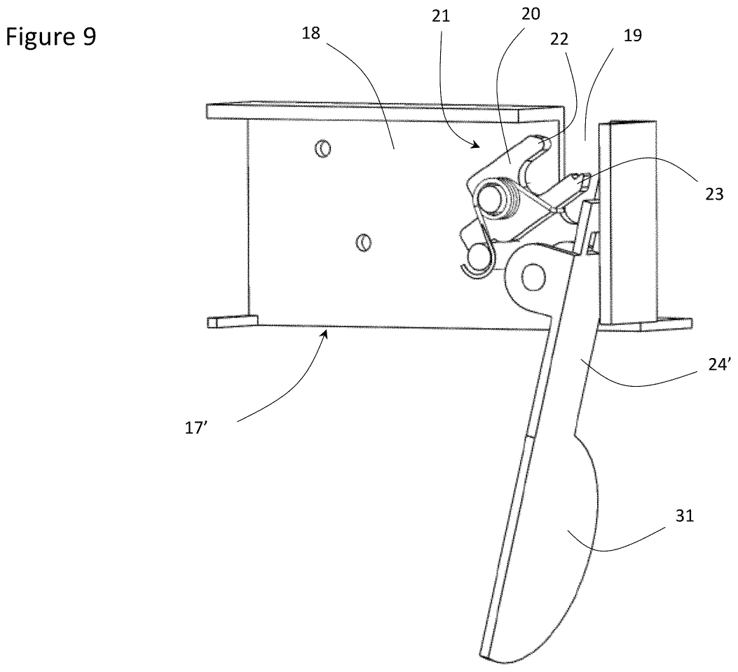

With reference to FIGS. 1-10, an embodiment of a vermin trap 1 of the present invention includes a housing 2, with a trap opening 3 in one end thereof. In the illustrated embodiment the housing 2 is rectangular and the trap opening 3 is round, but other housing shapes, e.g. cubic, cylindrical, etc., and other opening shapes, e.g. square, oval, etc., are possible. A chamber 4 is provided inside the housing 2, accessible via the trap opening 3, for supporting any bait used to entice the vermin into the trap 1, and enabling the vermin to partially enter, e.g. just the head or upper torso, into the housing 2 for termination. The vermin may be any pest or undesired animal or creature, such as mice or rats. A second door 6 may be provided in a side of the housing 2 providing additional access to the chamber 4 to load the chamber 4 with bait and/or facilitate cleaning of the chamber 4 after use. The second door 6 may be a sliding door, which slides vertically or horizontally in a groove formed in the wall of the chamber 4, as illustrated, or the second door 6 may be any other suitable structure, e.g. pivoting about some form of hinge, and secured, e.g. via clasp, to prevent unwanted opening.

To kill the vermin quickly upon passing through the trap opening 3 and partially into the chamber 4, a catcher for catching the vermin (dead or alive) in the form of a snare 7 may be positioned around the trap opening 3 in a groove 8 formed in the wall at the end of the housing 2 around the trap opening 3. The snare 7 may include a snare opening 9 at least as large as the trap opening 3 to ensure the snare 7 is hidden from view and does not obstruct the trap opening 3. Ideally, the snare opening 9 is the same size and shape as the trap opening 3, but various other size and shape combinations are possible. The groove 8 is accessible, i.e. open, from the top of the housing 2 enabling the snare 7 to reciprocate vertically therein trapping the vermin between the bottom of the snare and the upper wall of the trap opening, thereby breaking the neck or back of the vermin entering the chamber 4.

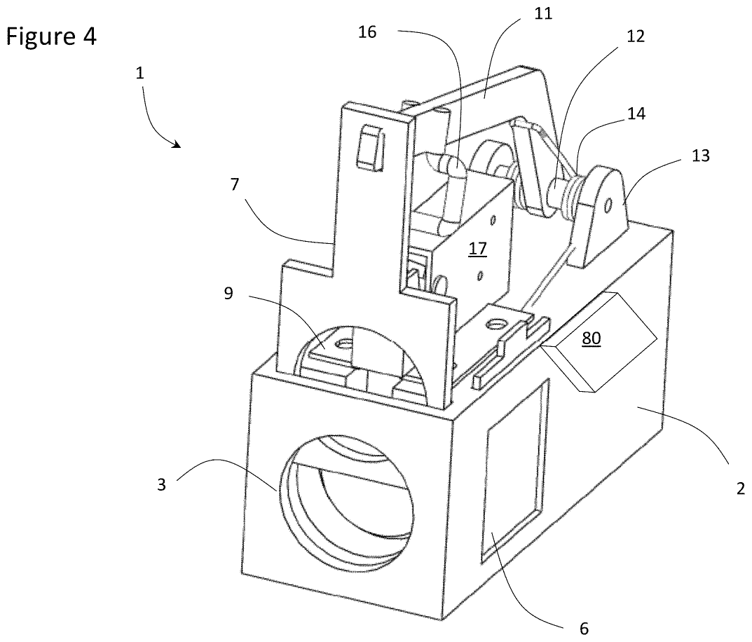

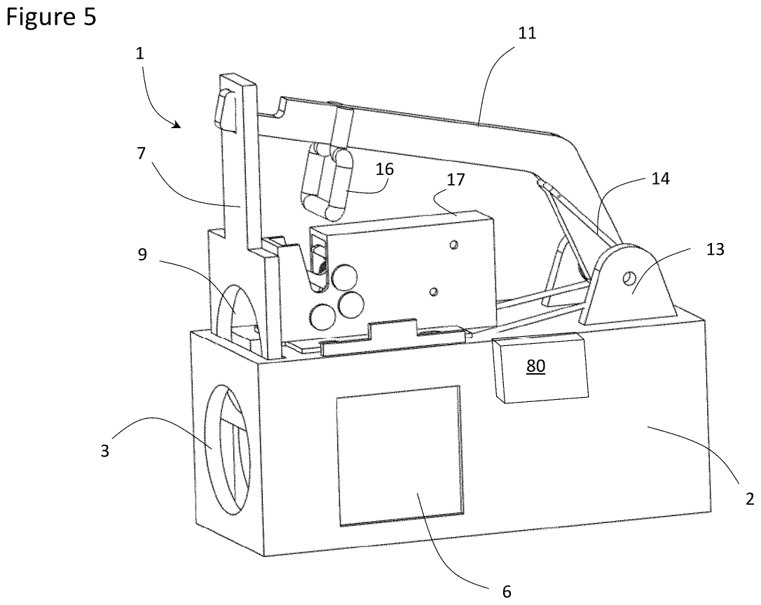

A striker mechanism for connecting the catcher, i.e. snare 7, to a latch 17 includes a striker arm 11 rotatably or pivotally connected at a first end to an upper end of the snare 7, and rotatably or pivotally connected at a second end to the housing 2, e.g. the top of the housing 2. The striker arm 11 is normally biased, e.g. spring biased, into an upper (“sprung”) position (FIGS. 4 and 5), with the first end thereof extending upwardly, which slides the snare 7 upwardly for engaging the vermin in the trap opening 3 and the snare opening 9. In the illustrated embodiment, the second end of the striker arm 11 is pivotally connected to the housing 2 via an axle 12 mounted in bearing brackets 13 fixed to the housing 2. A torsional spring 14 may be used to spring bias the striker arm 11 into the upper position, for example by wrapping the torsional spring 14 around the axle 12 on either side of the spring arm 11 with the ends of the torsional spring 14 contacting the housing 2 and a central loop engaging the striker arm 11 for biasing the striker arm 11. Alternative means for spring biasing the striker arm 11 are also possible including forming the striker arm 11 out of a resilient material.

The striker arm 11 may also be locked in a lower (“set”) position (FIGS. 1-3) by forcing, e.g. manually or mechanically, the striker arm 11 to rotate against the force of the spring bias, e.g. torsional spring 14, whereby the snare 7 is positioned around the trap opening 3. To hold the striker arm 11 in the set position, a striker bar 16 may be mounted on the striker arm 11 for engaging a latch 17 mounted on the housing 2. In the illustrated embodiment, the striker bar 16 comprises a U-shaped or C-shaped striker arm or bar, but any suitable size and shape of striker are possible.

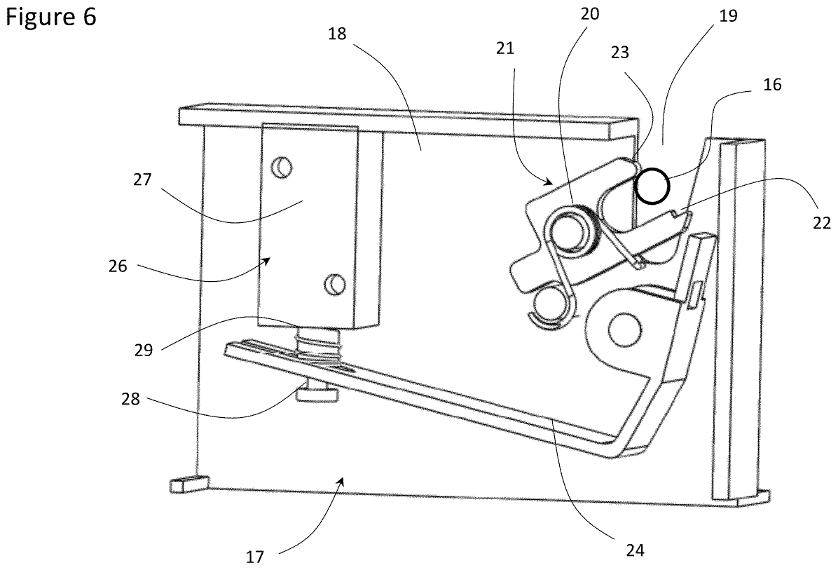

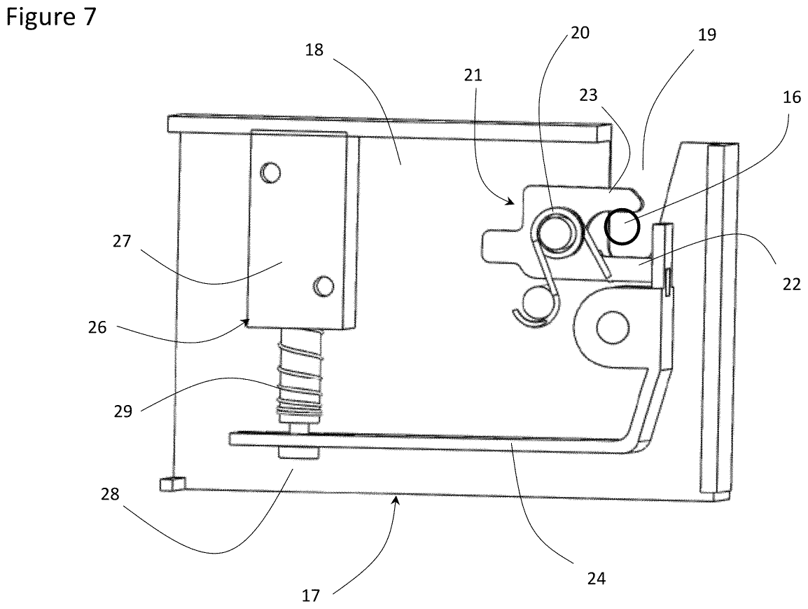

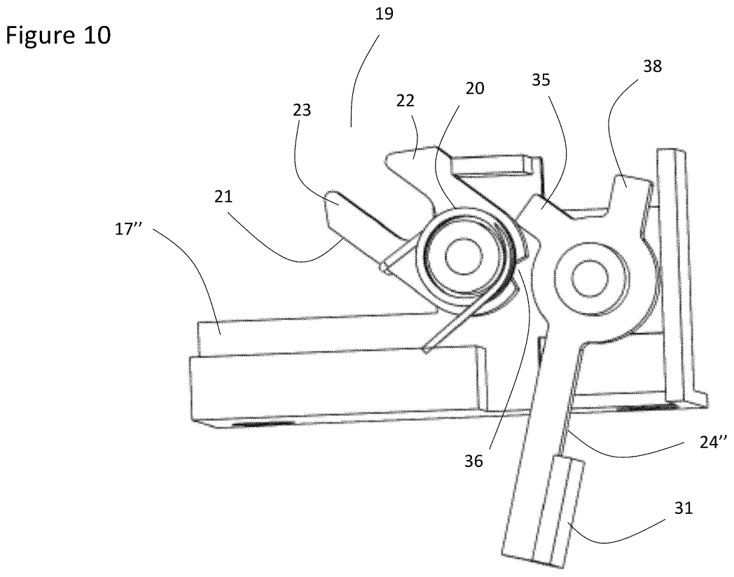

With reference to FIGS. 6-14, an embodiment of the latch 17 may include an outer casing 18 with an opening or a slot, e.g. fish mouth opening, 19 for receiving the striker bar 16. Inside the outer casing 18, a latching lever, e.g. a fork bolt lever, 21 is rotatably mounted proximate the slot 19 and spring biased to an open (“sprung”) position, see FIG. 6, e.g. via a torsion spring 20, enabling the striker bar 16 to slide into the slot 19 and engage the latching lever, e.g. a lower tine 22 of the fork bolt lever 21. As the striker bar 16 engages the lower tine 22 of the fork bolt lever 21, the fork bolt lever 21 rotates into a closed (“set”) position, see FIG. 7, with an upper tine 23 of the fork bolt lever 21 extending across the slot 19 holding the striker bar 16 in place. A locking lever 24 is provided, e.g. pivotally mounted inside the outer casing 18 about an axis parallel to the axis of rotation of the latching lever 21, for holding the latching lever, e.g. fork bolt lever, 21 in place in the set position. In the embodiment illustrated in FIGS. 6 and 7, the locking lever 24 engages an end of one of the upper or lower tines 22 or 23, e.g. the lower tine 22; however, in alternative embodiments, illustrated in FIGS. 10-13, the locking lever 24 may engage the latching lever, e.g. fork bolt lever, 21 at a rear end thereof. In the illustrated embodiment, the locking lever 24 includes a hole for receiving the end of the lower tine 22. The end of the lower tine 22 may include an angled cam surface at a leading surface thereof for engaging the locking lever 24 and ensuring the locking lever 24 rotates enough until the end of the lower tine 22 fits into the hole in the locking lever 24.

The locking lever 24 may be actuated, i.e. disengaged from the fork bolt lever 21, which releases the striker bar 16, thereby releasing the striker arm 11 to lift the snare 7, by the vermin entering the chamber 4 via the trap opening 3 and activating a trigger mechanism. The trigger mechanism may include an electrical sensor 30 or a mechanical force applicator 31, positioned in the chamber 4. With reference to FIGS. 6, 7, 12 and 13 the trigger mechanism may also include an actuator, such as a solenoid 26 comprising a coil 27, a piston 28, and a spring 29 biasing the piston 28, e.g. into the outer (“set”) position. Activation of the solenoid 26 may either retract or extend the piston 28, thereby rotating the locking lever 24 and disengaging the locking lever 24 from the latching lever 21. The actuator may be another suitable component, such as a stepper or servo motor, magnetic latch etc.

The solenoid 26 may be activated by any suitable sensor 30 provided in or around the trap opening 3 and/or the chamber 4. As an example, the chamber 4 may include a capacitive sensor 30 on the floor thereof to sense contact by a predetermined amount of force, e.g. above a threshold amount of pressure, such as a mouse, rat or squirrel would apply, whereby smaller insects or animals would not activate the sensor 30 causing undesired tripping of the trap 1. Alternatively, the sensor 30 may comprise a boundary crossing detector, such as an integrated boundary crossing detector, or a separate camera 90, e.g. with boundary crossing software, mounted in the chamber 4, e.g. motion detector, which activates the solenoid 26 upon triggering. The sensor 30 may also include animal recognition functionality, including a controller 80 and the camera 90 mounted in or near the trap 1, e.g. in the chamber 4, which captures an image of an animal entering the trap 1, and compares the image to a database of known animals. Accordingly, the trigger may be activated if the animal matches a known set of vermin or “pests”, e.g. mice, rats, raccoons, skunks, squirrels, birds etc, and/or if the animal does not match a known set of “friendly animals”, e.g. cats, dogs, chipmunks, squirrels, racoons, skunks, birds, human body parts etc.

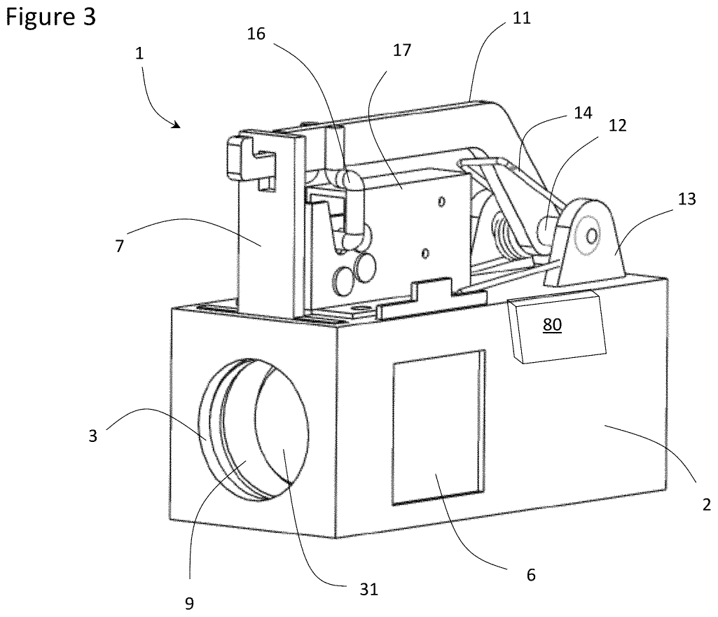

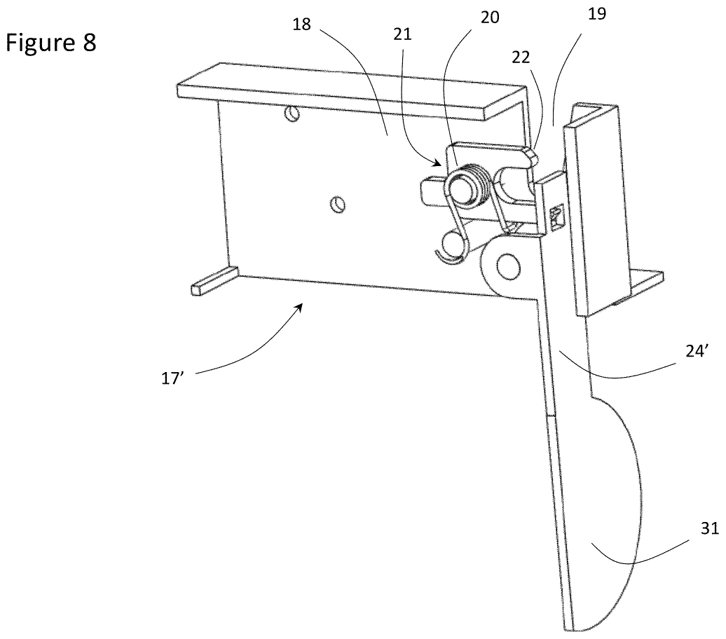

Alternatively, as illustrated in FIGS. 8-11, a latch 17′ or 17″ may include a locking lever 24′ or 24″, which may be actuated by applying force to a force applicator 31 directly or indirectly mechanically connected to the locking lever 24′ or 24″. The force applicator 31 may be positioned directly in the path of the animal in the trap opening 3, behind the trap opening 3 (FIG. 3), or the force applicator 31 may be positioned somewhere in the chamber 4, e.g. parallel to the floor, extending up perpendicular to the floor or extending down from the top perpendicular to the floor. Accordingly, when the vermin applies a force to the force applicator 31, the locking lever 24′ or 24″ is rotated directly or indirectly via intermediate mechanical linkages to disengage the fork bolt lever 21 and release the striker arm 11 and the snare 7.

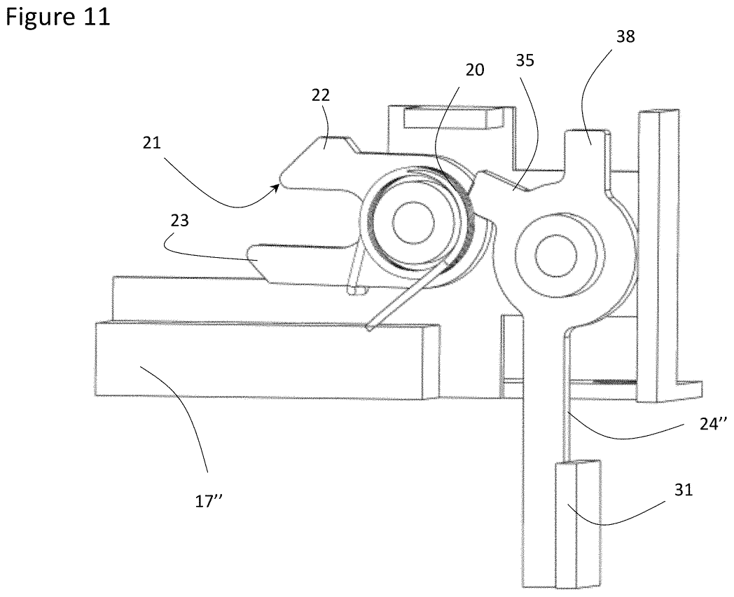

With reference to FIGS. 10 and 11, in an exemplary embodiment of the latch 17″, the locking lever 24″ engages the fork bolt lever 21 at a rear end thereof. In the illustrated embodiment, the locking lever 24 includes a detent 35 extending from one end thereof for engaging a notch 36 in the fork bolt lever 21. Accordingly, when a force is applied by the vermin to the force applicator 31, the locking lever 24″ is rotated, disengaging the detent 35 from the notch 36, enabling the locking (fork bolt) lever 21 to rotate, and releasing the striker bar 16.

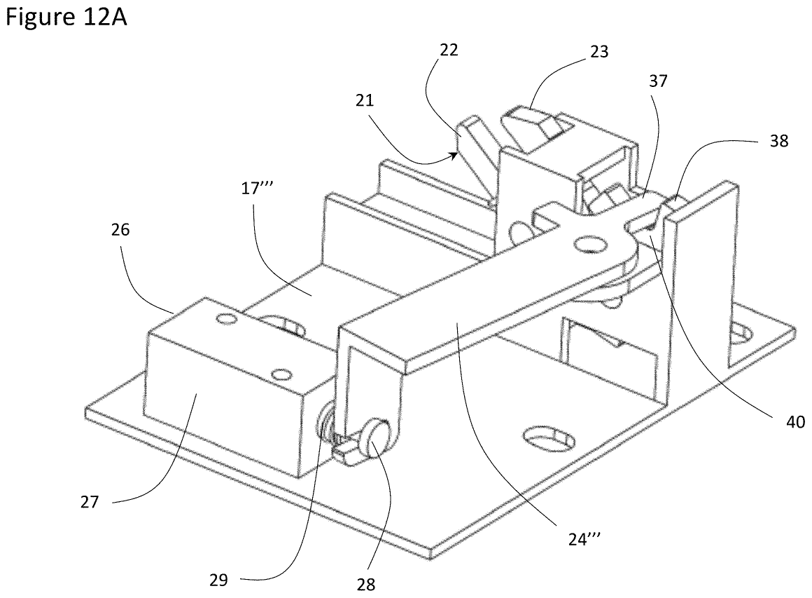

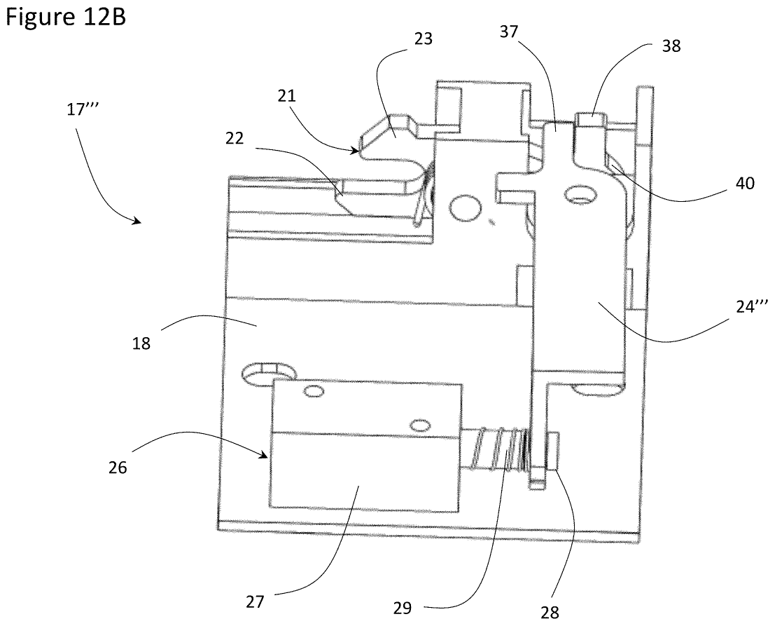

With reference to FIGS. 12A and 12B, in another exemplary embodiment of the latch 17′″, a cog 40, rotatable on the latch outer casing 18, is used as part of the locking lever to engage the fork bolt lever 21 at a rear end thereof, similar to the end of the locking lever 24 as above in FIGS. 10 and 11. A locking lever 24′″ is rotatably mounted in the latch outer casing 18 for engaging the cog 40. The trigger may include the solenoid 26 comprising the coil 27, the piston 28, and the spring 29 biasing the piston 28, e.g. into the outer (“set”) position. Activation of the solenoid 26 may either retract or extend the piston 28, thereby rotating the locking lever 24′″ about an axis perpendicular to the latching (fork bolt) lever 21, which forces a first tooth 37 on an end of the locking lever 24′″ to engage and rotate a second tooth 38 on the cog 40, thereby releasing the detent 35 of the cog 40 from the notch 36 of the latching lever 21.

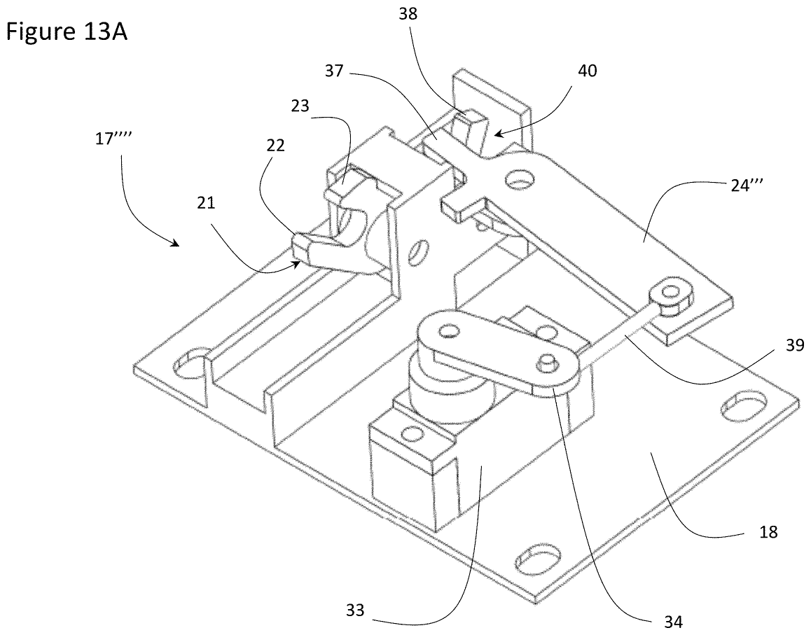

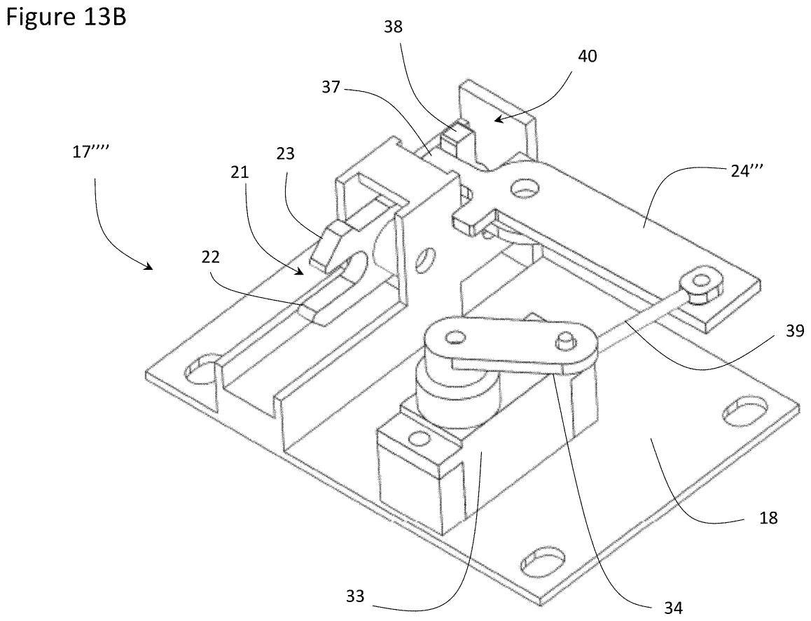

With reference to FIGS. 13A and 13B, in another exemplary embodiment of the latch 17″″, the cog 40, rotatable on the latch outer casing 18, is used as part of the locking lever to engage the fork bolt lever 21 at a rear end thereof, similar to the end of the locking lever 24 as above in FIGS. 10 and 11. The locking lever 24′″ is rotatably mounted in the latch outer casing 18 for engaging the cog 40. The trigger may include the actuator in the form of a servo or stepper motor 33 for rotating an actuating arm 34, which is connected directly or indirectly via intermediate linkage 39. Activation of the servo or stepper motor 33 may either rotate the actuating arm 39 clockwise or counterclockwise, thereby rotating the locking lever 24′″ about an axis perpendicular to the latching (fork bolt) lever 21, which forces a first tooth 37 on an end of the locking lever 24′″ to engage and rotate a second tooth 38 on the cog 40, thereby releasing the detent 35 of the cog 40 from the notch 36 of the latching lever 21. The servo or stepper motor 33 or other suitable actuator may replace the solenoid 26 as the actuator in any of the aforementioned latches 17.

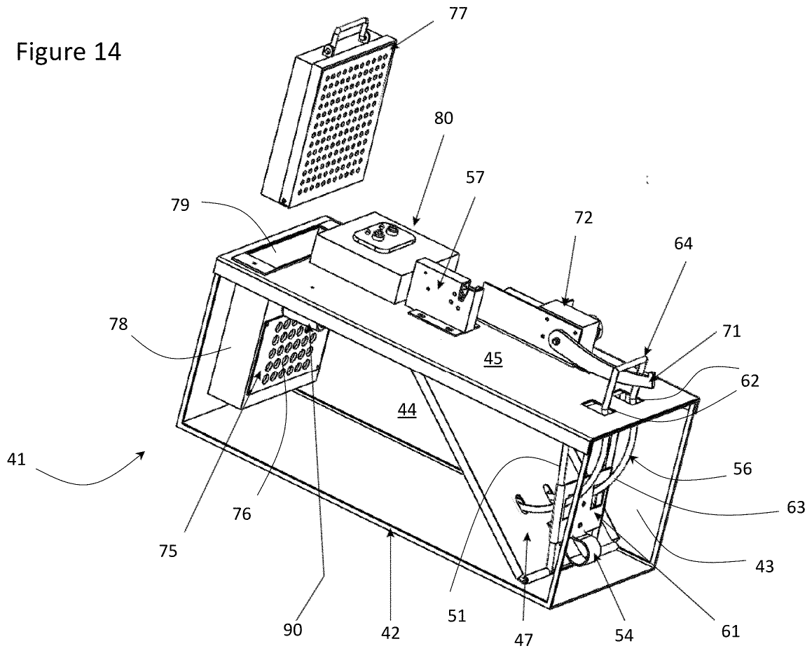

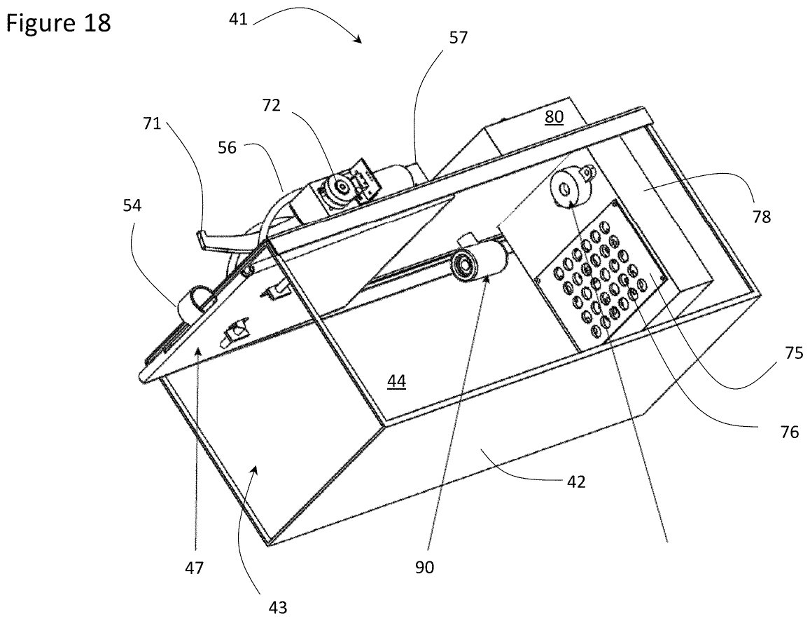

With reference to FIGS. 14-18, another embodiment of a vermin trap 41 includes a housing 42, with an opening 43 in one end thereof In the illustrated embodiment the housing 42 is rectangular and the opening 43 is rectangular, but other housing shapes, e.g. cubic, cylindrical, etc., and other opening shapes, e.g. round, oval, etc., are possible. A chamber 44 is provided inside the housing 42, accessible via the opening 43, for supporting any bait used to entice the vermin into the trap 41, and enabling the vermin to fully enter, e.g. the entire head or upper torso, into the housing 42 for capture. The housing 42 may be constructed of chain-link, wire-mesh, sheet metal, plastic, wood, fiberglass or other suitable cage material providing additional access to the chamber 44, e.g. to load the chamber 44 with bait and/or facilitate cleaning of the chamber 44 after use.

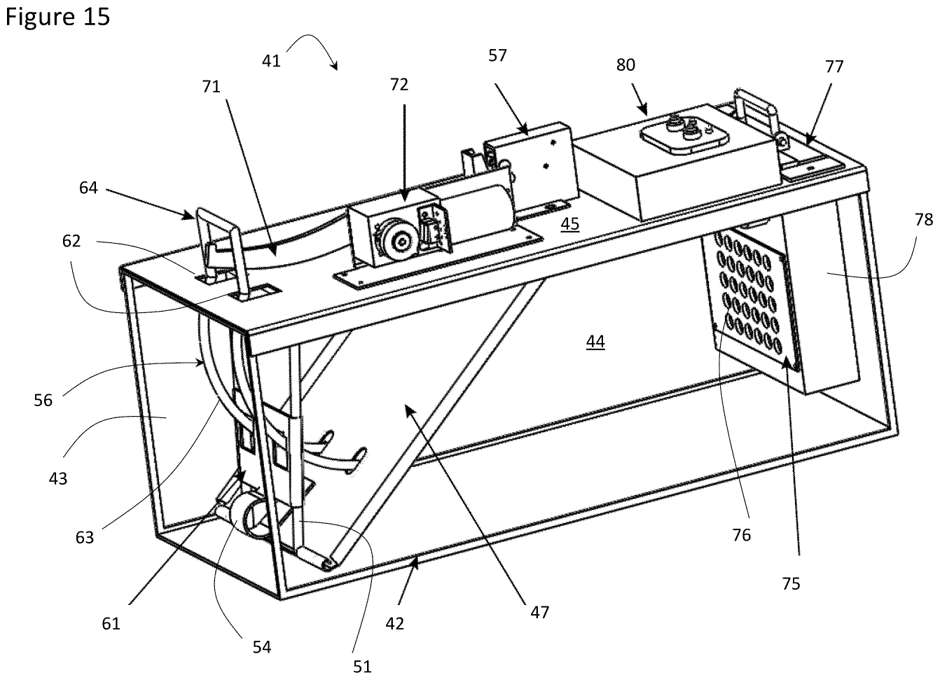

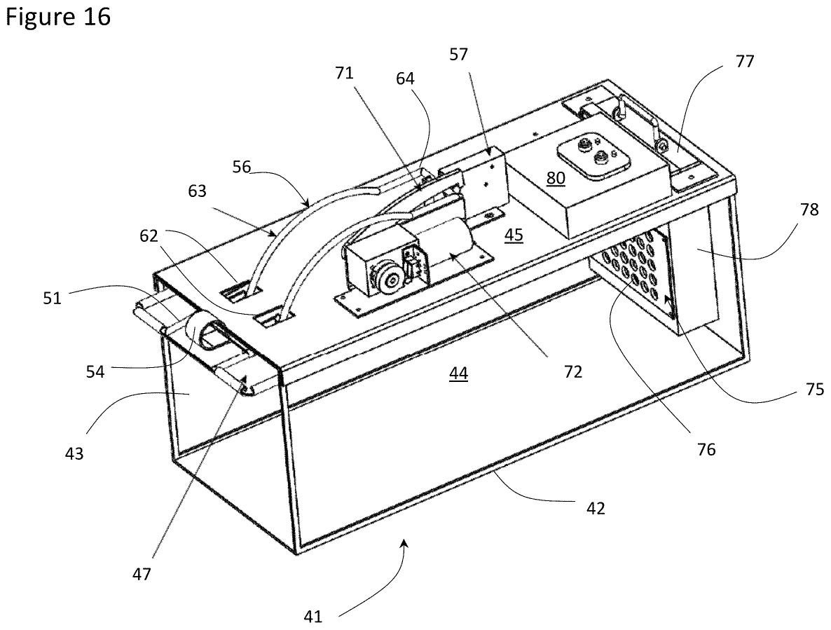

To capture the vermin upon passing through the opening 43 and into the chamber 44, a catcher for catching the animal (dead or alive) in the form of a door 47 may be positioned above the opening 43 pivotally mounted from the top of the housing 42 into the opening 43. The door 47 may be at least as large as the opening 43 and may be pivoted up into the chamber 44 to ensure the door 47 is hidden from view and does not obstruct the opening 43 until activated. Ideally, the door 47 is the same size and shape of the opening 43, but various other size and shape combinations are possible. The door 47 may rotate from a horizontal set position parallel to the top of the chamber 44 to a vertical or angled sprung position blocking the opening 43 trapping the vermin in the chamber 44. The door 47 may be pivotally attached to the top of the housing 42 proximate the mid-way point of the housing 42 and extend outwardly from the opening 43 in the set position, whereby in the sprung position the door 47 drops into the chamber 44 greatly reducing the volume of the chamber 44 and limiting the vermin's ability to move around in the trap 41. A compression spring 54 may be used to spring bias the door 47 into the lower sprung position, for example by mounting the compression spring 54 to the upper wall 45 of the housing 42 or an upper surface of the door 47, whereby the outer free end of the door 47 gets forced into the compression spring 54 when locked into the upper set position (FIGS. 16-18), and the compression spring 54 more rapidly and forcefully pushes the door 47 into the down sprung position (FIGS. 14 and 15).

A door locking feature for holding the door in the lower spring position may comprise a locking arm 51 rotatably or pivotally connected at a first end to an outer free end of the door 47, and slidable or reciprocatable at a second end relative to the housing 42, e.g. along the top of the chamber 44. The locking arm 51 may be spring biased into a vertical, down (“sprung”) position, with the first end thereof extending downwardly, when the door 47 moves, e.g. pivots, downwardly for engaging the animal in the chamber 44. In the illustrated embodiment, the second end of the arm 51 is mounted to the housing 42 via a track mounted to the upper wall 45 of the chamber 44. The vertical or past vertical position opposing rotation of the locking arm 51 prevents the door 47 from being lifted up by the animal. Alternative means for spring biasing the door 47 and the door locking feature are also possible, including forming the locking arm 51 out of a resilient material.

The locking arm 51 may also be held in an upper (“set”) position by forcing, e.g. manually or mechanically, the locking arm 51 and the door 47 to rotate against the force of the spring bias, whereby the locking arm 51 and the door 47 are folded together and positioned above the opening 43 parallel to the upper wall 45 of the housing 42.

To hold the door 47 in the upper set position, a striker mechanism including a striker arm 56 may be connected to the door 47 for engaging a latch 57 mounted on the housing 42. The latch 57 may be comprised of the same elements as the latch 17, 17′, 17″ or 17′″, as hereinbefore described, or any other suitable latch. In the illustrated embodiment, the striker arm 56 comprises an elongated U-shaped striker arm, but any suitable size and shape of striker arm are possible. The striker mechanism may extend from the door 47, the arm 51, the housing 42 or any combination of the door 47, the locking arm 51 and the housing 42. As illustrated, a lower end of the striker arm 56 extends from proximate the outer free end of the door 47 through a bracket 61 on the locking arm 51, and through holes 62 in the upper wall 45 of the housing 42 for holding and guiding the striker 56 as the door 47 rotates. The striker arm 56 may comprise a door pulling portion 63, e.g. comprised of a pair of curved or arcuate rods mirroring the radius of curvature of the door, and a striker bar 64 at an outer free end. As the striker arm 56 is vertically lifted from the down sprung position, the door pulling portion 63 engages and pushes in the locking arm 51, e.g. via the bracket 61 and/or by pushing the inner ends of the locking arm 51 proximate the holes 62, thereby unlocking the door 47 and enabling rotation of the door 47. Subsequent lifting of the striker arm 56, pulls up the outer free end of the door 47. As the striker arm 56 is lifted vertically, the door pulling portions 63, e.g. the curved rods, facilitate movement, e.g. rotation, of the striker 56 as the curved rods are fed through the holes 62, until the striker bar 64 engages the latch 57 in the upper set position.

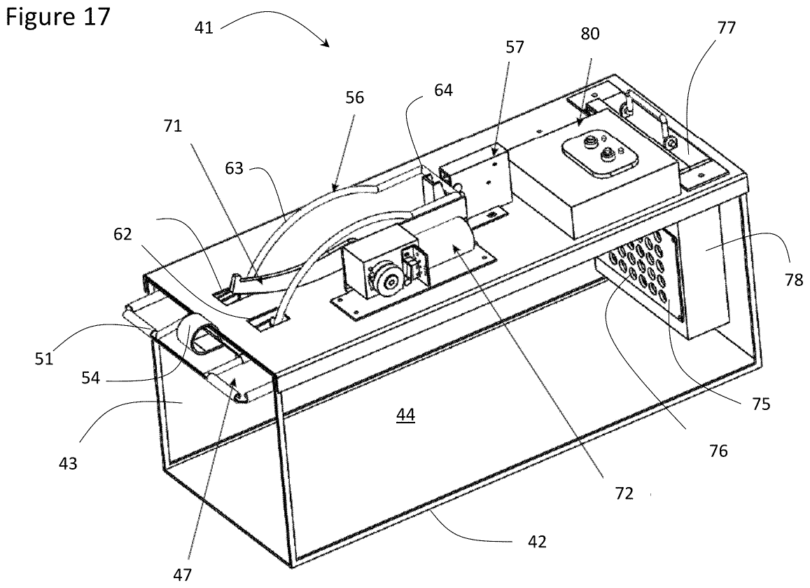

A reset arm 71 may also be provided for mechanically resetting or repositioning the striker mechanism back into the set position. As illustrated in FIGS. 14-18, the reset arm 71 may be pivotally mounted on the upper wall 45 of the housing 42 for pulling on the striker arm 56 and rotating the door 47 from the sprung position back to the set position. Ideally, an outer free end of the reset arm 71 engages the striker arm 56, e.g. extending between curved rods of the door pulling portions 63 and engaging the striker bar 64. A motor 72 may be provided, e.g. on the top of the housing 42, for rotating the reset arm 71, thereby pulling the striker arm 56 until the striker bar 64 is engaged by the latch 57, as hereinbefore described with reference to latches 17, 17′, 17″ and 17′″. Accordingly, to reset the trap 41, the reset arm 71 is rotated from the sprung position (FIG. 15) to the set position (FIG. 16), pulling on the striker arm 56 until the striker bar 64 is locked in the set position in the latch 57. Then the reset arm 71 may be rotated back to a reset position (FIG. 17), i.e. same as sprung position for the reset arm 71, with door 47 in set position, so that the reset arm 71 does not interfere with the activation of the door 47.

In this embodiment, a trigger, which may comprise a mechanical or electrical sensor 75, as hereinbefore described with reference to sensors 30 or 31, is provided configured for de-activating the latch 57 and/or activating the catcher, e.g. the door 47. The sensor 75 may comprise a plate 76 suspended from the top of the chamber 44. The plate 76 may be mechanically linked to the locking lever 24 or electrically connected to the solenoid 26 (See FIGS. 6 and 7) or some other feature of the latch 57. To capture the vermin alive, the plate 76 may be positioned at the inner end of the chamber 44 to ensure the animal has fully entered into the trap 41 before the door 47 is activated, thereby ensuring the vermin does not sustain any major injuries from the door 47 during activation.

Bait for attracting the vermin into the chamber 44 may be provided in the form of a bait box 77 slidable into a bait holder 78 in the rear of the chamber 44, e.g. behind the sensor 75. The bait holder 78 may comprise a mounting bracket or a container with an opening 79 accessible from the upper wall 45 of the housing 42 for easily replacing the bait or bait box 77 inside the chamber 44.

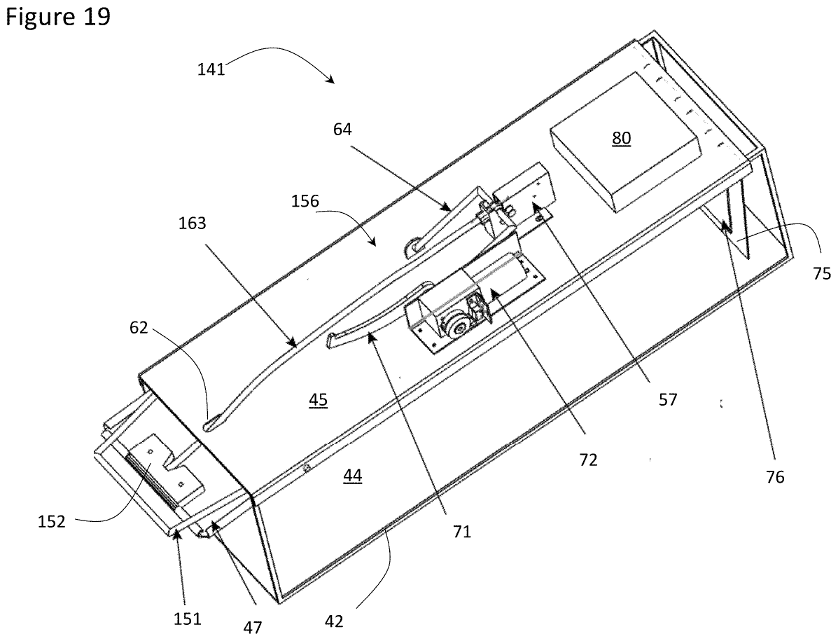

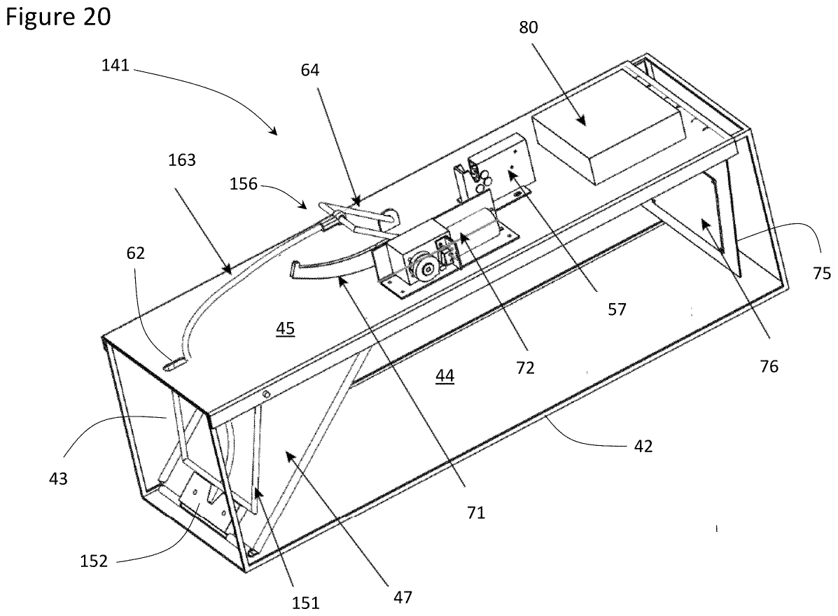

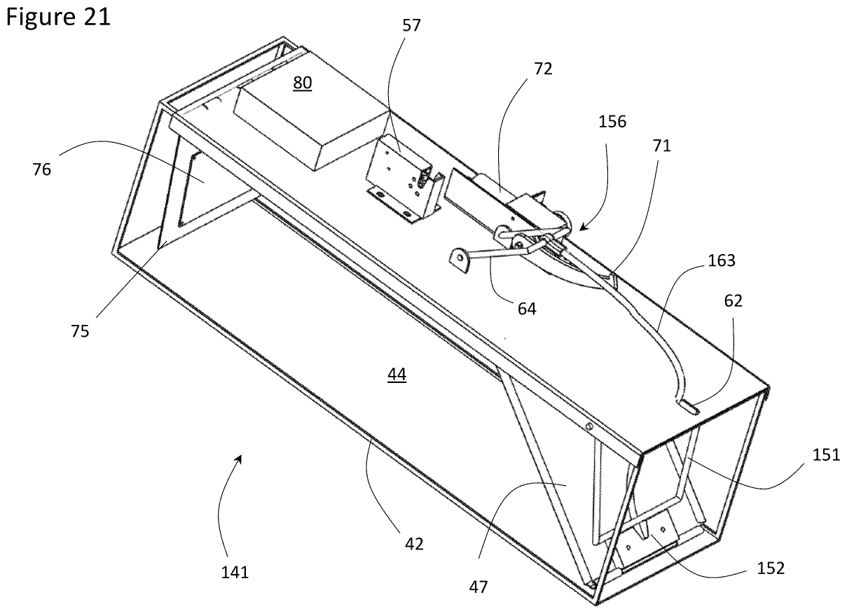

As illustrated in FIGS. 19 to 21, in an alternative embodiment in which like reference numerals indicate like elements in the above embodiments, the striker mechanism may be replaced by a striker arm 156, which includes a door pulling portion 163 in the form of a cord extending from proximate the outer free end of the door 47 through or around a locking arm 151, and through a hole 62 in the upper wall 45 of the housing 42. The striker arm 156 may also include a striker bar 164 pivotally mounted to the upper wall 45 of the housing 42. The locking arm 151 is provided pivotally mounted to the upper wall 45 of the housing 42, and configured to engage a detent 152 mounted on the door 47 when in the down sprung position. As the striker arm 156 is vertically lifted from the down sprung position, the door pulling portion 163 disengages the locking arm 151 from the detent 152, thereby unlocking the door 47 and enabling rotation of the door 47 and the locking bar 156 in the same direction into a sandwiched position parallel to the upper wall 45 of the housing 42. Subsequent lifting of the striker 156, pulls up the outer free end of the door 47. As the striker arm 156 is rotated, the door pulling portions 163 facilitate movement, e.g. rotation, of the striker arm 156 as the cord of the door pulling portion 163 is fed through the hole 62, until the striker bar 64 engages the latch 57 in the upper set position.

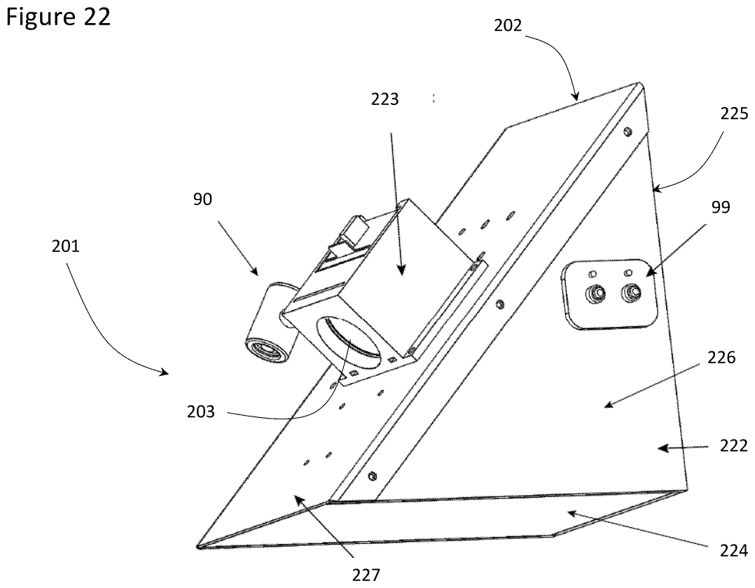

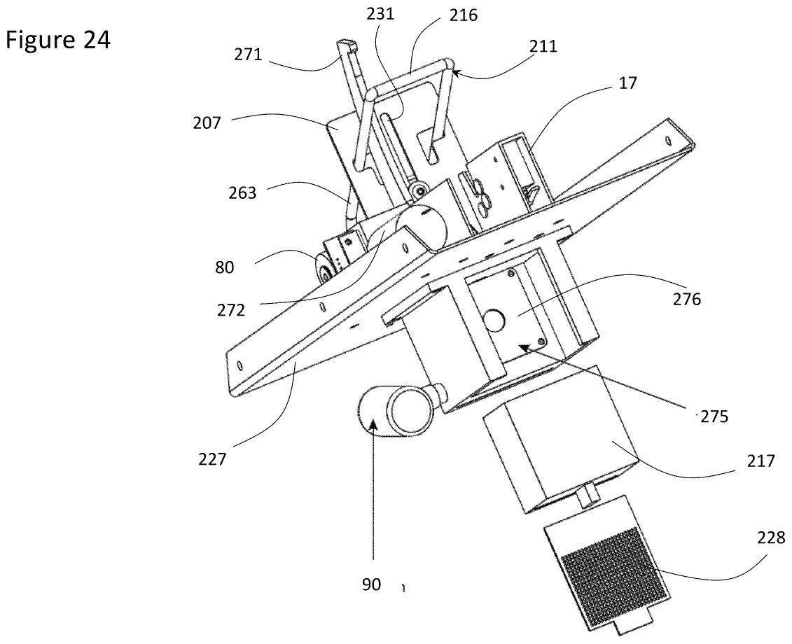

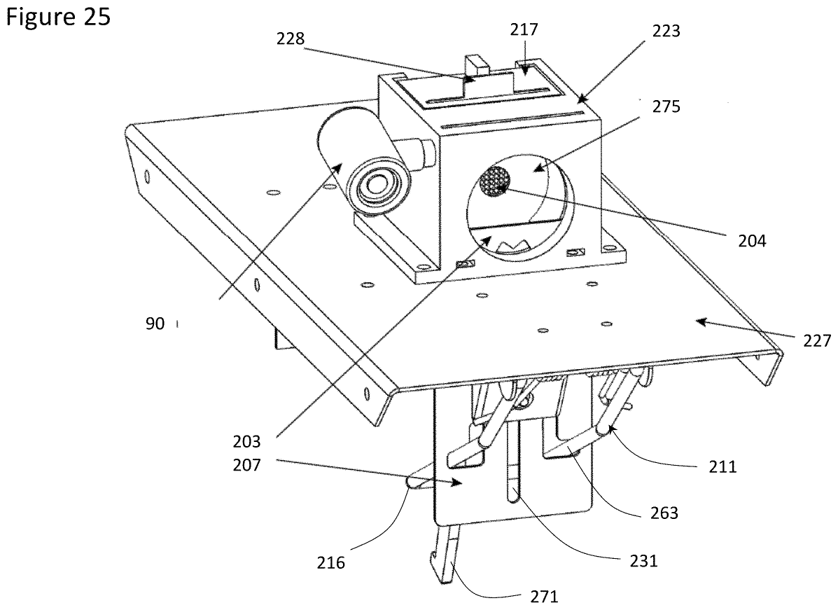

With reference to FIGS. 22-28, an embodiment of an animal trap 201 of the present invention includes a housing 202, with a circular opening 203 for receiving a head of a vermin to be killed. In the illustrated embodiment the housing 202 comprises a main, e.g. triangular, housing 222 for enclosing and protecting the trap mechanism, and a rectangular snare box housing 223 including the opening 203. Other housing shapes, e.g. cubic, cylindrical, etc., and other opening shapes, e.g. square, oval, etc., are possible. The main housing 222 includes a rectangular horizontal base 224 for mounting on the ground, a substantially vertical back 225 wall, and triangular vertical side walls 226. The snare box housing 223 may be mounted on a sloped or vertical front wall 227, proximate a middle thereof, with the opening 203 facing downwardly. The sloped front wall may be at an acute angle, e.g. 20°-90°, preferably 45°-80°. A chamber 204 is provided inside the snare box housing 223, accessible via the opening 203, for supporting any bait 217 used to entice the animal into the trap 201, and enabling the animal to partially enter, e.g. just the head or upper torso, into the chamber 204 for termination. A second access 206 may be provided in a side of the snare box housing 223 providing additional access to the chamber 204 to load the chamber 204 with the bait 217. The bait 217 may be in the form of a sliding container, which slides vertically or horizontally in a groove formed in the wall of the snare box housing 223, as illustrated. A bait screen 228 may be included to prevent direct access to the bait 217 by the vermin.

To kill the vermin quickly upon passing through the opening 203 and partially into the chamber 204, a catcher for catching the animal (dead or alive) in the form of a snare 207 may be positioned around the trap opening 203 in a groove 208 extending between the snare box housing 223 and the main housing 222 through the front wall 227. A snare plate 229 may be mounted on the front wall 227 for supporting the snare 207 during reciprocation. The snare 207 may be connected to the snare plate 229 via a fastener 230 extending through an elongated slot 231 in the snare 207 into the snare plate 229, enabling the snare 207 to reciprocate in and out of the chamber 204 of the snare box housing 223. The snare 207 may include a snare opening 209 at least as large as the trap opening 203 to ensure the snare 207 is hidden from view and does not obstruct the trap opening 203. Ideally, the snare opening 209 is the same size and shape of the trap opening 203, but various other size and shape combinations are possible. The groove 208 is accessible between the snare box housing 223 and the main housing 222 through the front wall 227 enabling the snare 207 to reciprocate therebetween trapping the animal between a side of the snare 207 and the wall of the snare box housing 223, thereby breaking the neck or back of the animal entering the chamber 204. The front wall 227 is slanted or vertical, i.e. perpendicular, relative to the base 224, whereby any vermin exterminated by the trap 201 will fall or slide back down the front wall 227 out of the way of the opening 203 enabling the trap 201 to be used and reused multiple times without having to remove the exterminated vermin from the trap 201. Ideally, the opening 203 is positioned far enough off the ground, e.g. 4″ to 12″ and/or on top of a mound or sloped area that the dead vermin will fall further away from the trap 201 and not block the opening 203. A motorized arm may be provided to move the dead vermin away from the trap 201. Alternatively, a container, such as a bucket, may be provided with or without a trap door to collect vermin exterminated by the trap 201. The trap door may be controlled by the trap controller 80, e.g. opened when the snare 207 is sprung or reset.

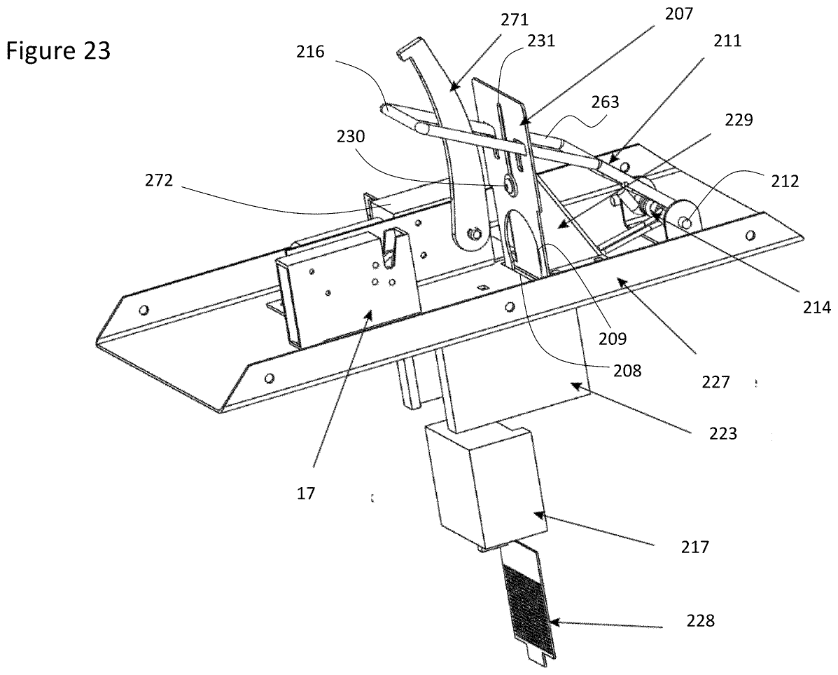

A striker mechanism for connecting the catcher, e.g. snare 207, to the latch 17 may include a striker arm 211, which may be rotatably or pivotally connected at a first end to an upper end of the snare 207, and rotatably or pivotally connected at a second end to the front wall 227 of the main housing 222. The striker arm 211 is normally spring biased into an upper (“sprung”) position (FIGS. 23-25), with the first end thereof extending upwardly, which slides the snare 207 upwardly for engaging the vermin in the trap and snare openings 203 and 209. In the illustrated embodiment, the second end of the striker arm 211 is pivotally connected to the front wall 227 of the main housing 222 via an axle 212 mounted in bearing brackets 213 fixed to the front wall 227. A torsional spring 214 may be used to spring bias the arm 211 into the upper sprung position, for example by wrapping the torsional spring 214 around the axle 212 on either side of the striker arm 211 with the ends of the torsional spring 214 contacting the front wall 227 and a central loop engaging the arm 211 for biasing the striker arm 211. Alternative means for spring biasing the striker arm 211 are also possible including forming the striker arm 211 out of a resilient material.

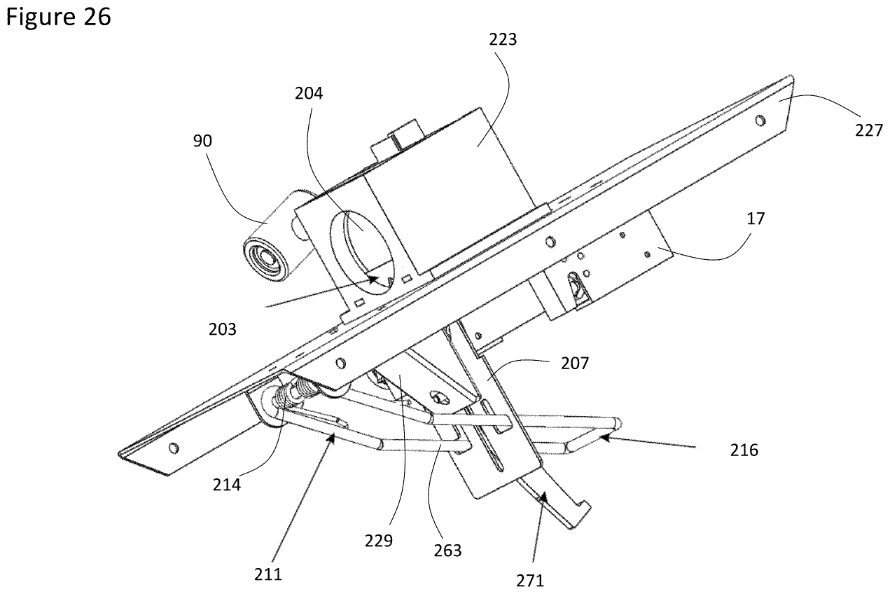

The striker arm 211 may also be locked in a lower (“set”) position (FIG. 26) by forcing, e.g. manually or mechanically, the striker arm 211 to rotate against the force of the spring bias, whereby the snare opening 209 is positioned around the trap opening 203. To hold the striker arm 211 in the set position, a striker bar 216 may be mounted on the striker arm 211 for engaging a latch, e.g. latch 17, mounted in the main housing 222, e.g. on the inner surface of the front wall 227. In the illustrated embodiment, the striker bar 216 comprises a U-shaped or C-shaped striker bar on the end of the striker arm 211, which comprises a pair of parallel rods, but any suitable size, shape and position of the striker bar 216 are possible.

In the illustrated embodiment of FIGS. 23-28, catcher or snare pulling sections 263 of the striker arm 211 extend through elongated holes or slots 231 in the snare 207, whereby rotation of the striker arm 211 causes the snare pulling sections 263 to engage the snare 207, thereby reciprocating the snare 207 from the set position to the sprung position or vice versa.

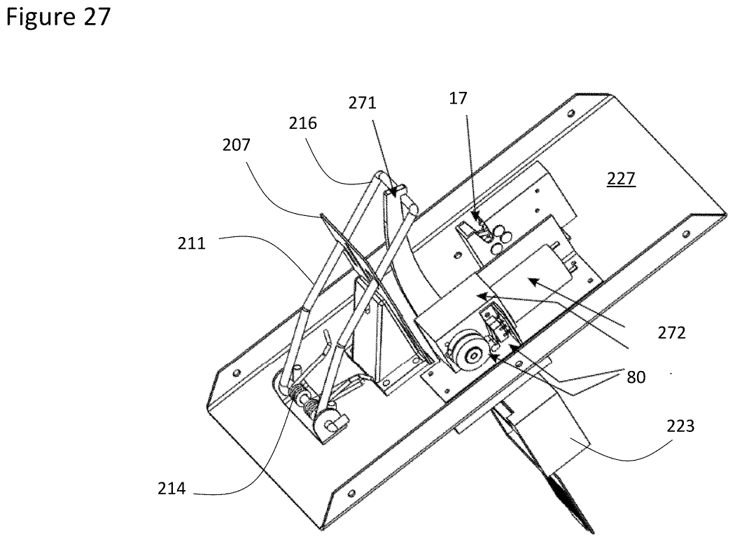

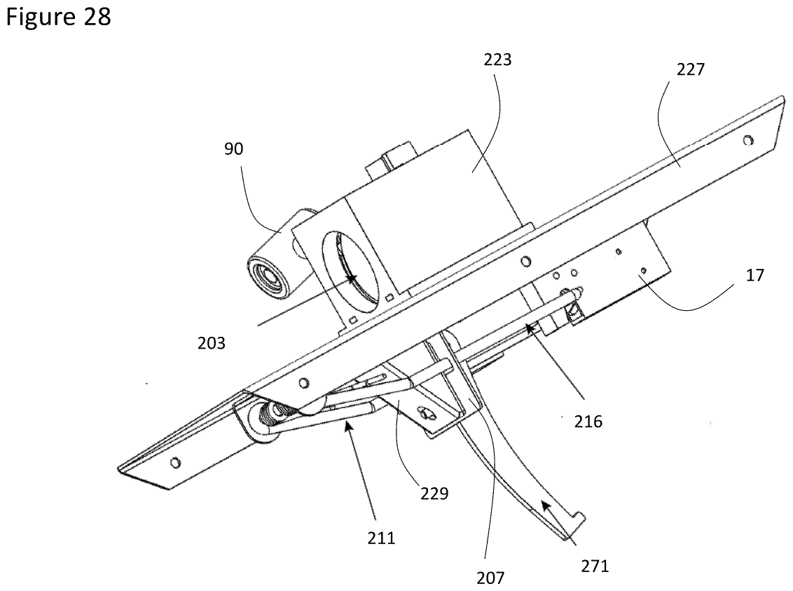

A reset arm 271 may also be provided for mechanically resetting the striker arm 211 back into the set position under control of the trap controller 80. As illustrated in FIGS. 26-28, the reset arm 271 may be pivotally mounted on the front wall 227 of the main housing 222 for pulling on the striker arm 211 and moving, e.g. reciprocating, the snare 207 from the sprung position (FIG. 26) back to the set position (FIG. 28). Ideally, an outer free end of the reset arm 271 includes a hook configured to engage the striker arm 211, for example extending between the rods of the striker arm 211 and engaging the striker bar 216. A motor 272 may be provided, e.g. mounted on the front wall 227 on the inside of the main housing 222, for rotating the reset arm 271, thereby pulling the striker arm 211 until the striker bar 216 is engaged by the latch, as hereinbefore described with reference to latches 17, 17′, 17″ and 17′″. Accordingly, to reset the trap 201, the reset arm 271 is rotated from the sprung position (FIG. 26) to the set position (FIG. 28), pulling on the striker arm 211 (FIG. 27) until the striker bar 216 is locked in the set position in the latch 17. Then the reset arm 271 may be rotated back to a reset position (FIG. 28) by the motor 272, i.e. same as sprung position for the reset arm 271, with snare 207 in set position, so that the reset arm 271 does not interfere with the activation of the snare 207.

In this embodiment, a trigger, which may comprise a mechanical or electrical sensor 275, is provided configured for de-activating the latch 17 and/or activating the catcher, e.g. the snare 207, as hereinbefore described with reference to sensors 30 and 75. The sensor 275 may comprise a plate 276 suspended from the top of the chamber 204. The plate 276 may be mechanically linked to the locking lever 24 or electrically connected to the solenoid 26 (see FIGS. 6 and 7) or some other feature of the latch 17. To capture the vermin alive, the plate 276 may be positioned at the inner end of the chamber 204 to ensure the vermin has fully entered into the trap 201 before the snare 207 is activated, thereby ensuring the vermin does not escape.

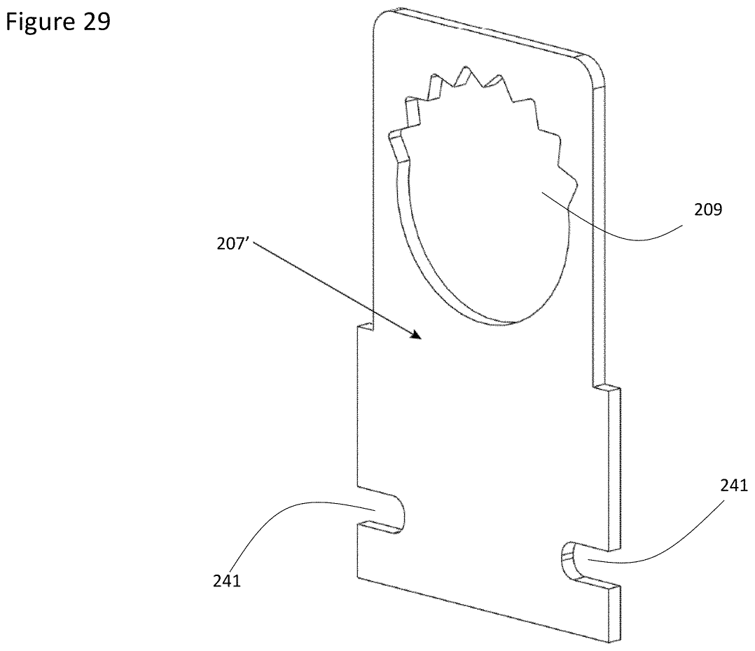

FIG. 29 illustrates another embodiment of the snare 207′ with a snare opening 209. Instead of the slots 231, the snare 207′ includes a pair of grooves 241, one on each side of the snare 207′ for engaging the pair of rods of the striker arm 211.

Any one or more of the latch 17, the striker bar 16, 64 or 216, the reset arm 71 or 271, the reset motor 72 or 272, the trap controller 80, the camera 90, and the sensors 30, 75 or 275 may be retrofitted into existing traps to upgrade their functionality providing “smarter” and more effective traps. All of the traps 1, 41, 141 and 201 may include a modular construction facilitating set up, take down, part replacement, feature upgrades, and cleaning.

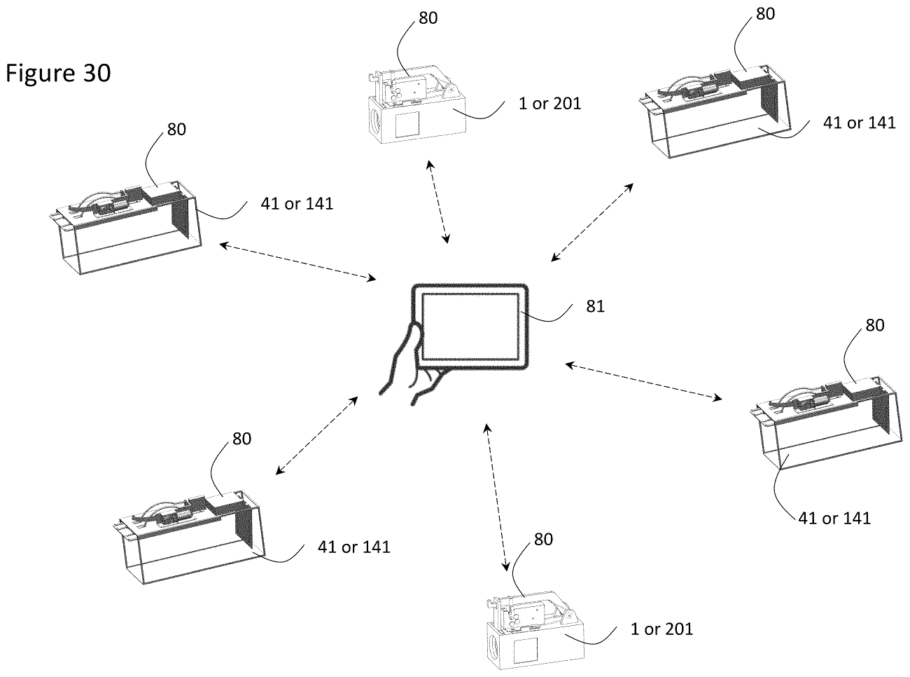

With reference to FIG. 30, the animal traps 1, 41, 141 and 201 may be monitored, set and reset remotely, using the trap controller 80 provided on each trap 1, 41, 141 and 201, each of which is connected to a user controller 81 via a suitable communication network, e.g. wifi, Bluetooth, RF, LoRa, 1G/2G/3G . . . , sub 1G, Zibgbee, Amazon Alexa™, Apple HomeKit™, Google Assistant™, etc. The user controller 81 may include a computer software application stored in non-volatile or non-transient memory and executable by a central processing unit providing a user interface for independently or group controlling each of the traps 1, 41, 141 or 201 in a network. Ideally, the user controller 81 includes an app, which is stored and executable on an individual's smart phone, tablet, laptop computer or PC. Each trap 1, 41, 141 and 201 may include a sprung indicator, e.g. a microswitch, that indicates that the trap 1, 41, 141 or 201 has been activated. For example, a micro switch may be positioned in the latch 7 or 47 for actuation by the latching lever 21, the locking lever 24, the solenoid 26 or the force applicator 31. Alternatively, the sprung indicator may be activated by rotation of the striker arm 11, 51 or 211, or movement of the catcher, e.g. the snare 7 or 207 or the door 47. Accordingly, whenever the trap 1, 41, 141 or 201 is sprung, the user will receive a “sprung” message from the respective trap controller 80, is transmitted by a transmitter in the trap controller 80 via email, text or some other suitable communication method and/or the user controller 81. The trap controller 80 and the user controller 81 may include a CPU, an MPU, an MCU, an SOC, a computer, a hybrid MPU/MCU, etc.

In some embodiments a camera 90, e.g. video or still, may be provided on or near the trap 1, 41, 141 or 201 configured to capture at least one of still images or analog or digital moving images, e.g. video, for recording or live streaming of what is in and/or around the trap 1, 41, 141 or 201, and in particular what is in or entering the chamber 4, 44 or 204. The camera 90 may operate either continuously or upon activation of the sprung indicator, which may also be sent to the user, providing an indication of what and if anything has been trapped, i.e. indicating an urgency of when the trap 1, 41, 141 or 201 should be recover, reset etc. The camera 90 may be activated by and/or include a proximity sensor or proximity sensor controller that activates the camera 90 and records when there is movement near the trap, which would save data and power by only using data when a vermin was near the trap, i.e. in a predetermined zone. The size of the predetermined zone may be adjusted via the controller 80 based on the location of the trap 1, 41, 141 or 201, and the type of vermin. The camera 90 could stop recording after a predetermined time limit, e.g. 1 minute, or after the trap is actuated or when no movement is detected for a predetermined time limit, e.g. 1 minute. The camera 90 may include a live cam, a webcam, and IPcam etc, with or without night vision capabilities, e.g. IR LED's. The camera 90 may be controlled by the trap controller 80, which may control the position, the zoom and the focus based on automatic controls or controls signals provided by the user via the user controller 81.

The trap controller 80 may also enable and/or disable the trigger, e.g. the sensor 30, 75 or 275 and/or the latch 17 based on a smart recognition system, e.g. one or more of a facial recognition system, an animal recognition system or an object recognition system. When the trap controller 80 includes smart recognition functionality, e.g. animal recognition, the controller 80 may activate the camera 90 mounted in or near the trap 1, 41, 141 or 201, e.g. in or beside the chamber 4, 44 or 204, which captures an image of an animal or creature or portion thereof, e.g. nose, paw or leg, in a predetermined zone, e.g. close to or entering the trap 1 or 41, 141 or 201, and then uses some form of smart recognition, e.g. compares the image or portion of the image to a database or library of known animals, e.g. body, face or nodal sections, found in a memory either directly connected to the trap controller 80 or the user controller 81 over a suitable network. Accordingly, the trigger and/or the latch 17 may be enabled by the trap controller 80, when the smart recognition considers that the animal matches a known set of vermin or “pests”, e.g. mice, rats, chipmunks, squirrels, racoons, skunks, birds, etc, and/or disabled when the animal does not match a known set of “friendly animals”, e.g. cats, dogs, chipmunks, squirrels, racoons, skunks, birds, human body parts etc, depending on the situation. Accordingly, when the trigger and/or the latch 17 is enabled, the vermin is then able to activate the trigger and release the catcher, as hereinbefore described; however, even if a friendly animal were to engage the trigger, the catcher would not be released. The animal recognition system may include a computer software application stored in non-volatile or non-transient memory and executable by a central processing unit providing in each trap controller 80, the user controller 81 or some other suitable controller in contact therewith.

In addition, each trap controller 80 may also be able to control the reset arm 71 or 271, i.e. the motor 72 or 272, locally via a user interface on the trap, or remotely, to reset the trap 1, 41, 141 and 201 from a remote location, e.g. 10 feet up to 100 miles or more, using a user interface on the central controller 81.

The trap controller 80 may also control the trigger, e.g. sensor 30, 75 or 275, e.g. the boundary crossing detector mounted in the chamber 4, e.g. motion detector, which activates the actuator, e.g. solenoid 26, upon triggering. When the sensor 30, 75 or 275 includes smart recognition functionality, e.g. animal recognition, the trap controller 80 may activate the camera 90 mounted in or near the trap 1, 41, 141 or 201, e.g. in the chamber 4, 44 or 204, which captures an image of an animal or creature or portion thereof, e.g. nose, paw or leg, entering the trap 1 or 41, 141 or 201 and compares the image to a database or library of known animals, e.g. bodies, face or nodal portion, found in a memory either directly connected to the trap controller 80 or the user controller 81 over a suitable network. Accordingly, the trigger may be activated by the trap controller 80, in response to the animal activating the boundary crossing detector and/or when the smart recognition considers that the animal matches a known set of vermin or “pests”, e.g. mice, rats, chipmunks, squirrels, racoons, skunks, birds, etc, and/or if the animal does not match a known set of “friendly animals”, e.g. cats, dogs, chipmunks, squirrels, racoons, skunks, birds, human body parts etc, depending on the situation.

The smart recognition system may include a smart facial/vermin/object recognition version, which initially uses a simple database to determine when to set off each trap 1, 41, 141 and 201, but over time aggregates images/videos from each individual trap or all traps in the network to build up a database. The trap controller 80 and/or the user controller 81 may analyze data and build up and continually update a database of vermin and/or “friendly” animals, determining when to trigger the trap, which will provide a better solution over time to only allow the trap to be set off by the designated vermin.

If a friendly animal or creature is detected by the camera 90 and the trap controller 80, an alarm or indicator, such as a visual alarm, e.g. a light, and/or an audible alarm, e.g. a speaker or buzzer, 95 may be provided for emitting a warning signal to scare off the friendly animal from entering the trap 1 or 201 or to scare the friendly animal out of the trap 41 or 141.

A keypad and/or display 99 may also be provided on each trap 1, 41, 141 or 201 to provide control, e.g. on/off, reset arms 71 and 271, and/or an indication of power, connectivity, “set” or “sprung” etc. The display 99 may include buttons, e.g. analog or digital, and/or lights, e.g. different colored LED's.

Each trap 1, 41, 141 and 201, i.e. the trap controller 80 and the actuator, e.g. the solenoid 26, may be powered by any suitable power supply, such as solar power, a DC power supply, e.g. a battery power supply, or an AC power supply, e.g. a standard wall plug.

Data from each of the traps 1, 41, 141 and 201 may be collected, e.g. via each trap controller 80 communicating over a suitable network or direct connection, in a central or distributed database. Info/data such as: how many times trap release, reset, how many animals caught, type of animal, variation of species, e.g. type of rat, time, temp, type of bait used, gps location, time activated. The data may be aggregated, analyzed and summarized to provide more information, which will enable the user to be more successful at trapping/killing the vermin they desire to trap/kill and avoid endangering other species of animals.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A vermin trap comprising:
a housing;
a catcher pivotally mounted on the housing, configured to be held in a set position and forced into a sprung position for trapping the vermin;
a latch comprising:
a base;
an actuator moveable on the base; and
a latching lever pivotally mounted on the base about a latch axis, spring biased into the sprung position and held in the set position by the actuator;
a striker mounted on the housing and connected to the catcher, and including a striker bar configured to be engaged by the latching lever in the set position and disengaged from the latching lever in the sprung position, for moving the catcher from the set position to the sprung position; and
a trigger configured to activate the actuator, thereby releasing the latching lever, and disengaging the striker bar from the latching lever, enabling the catcher to move to the sprung position to trap the vermin.

2. The vermin trap according to claim 1, wherein the actuator includes a solenoid reciprocatable on the base;
wherein the latch includes a locking lever pivotable on the base about a lever axis, and connected at a first end to an outer free end of the solenoid; and
wherein the latching lever is pivotally mounted on the base about a latch axis spring biased into the sprung position, and configured to engage a second end of the locking lever in the set position.

3. The vermin trap according to claim 2, further comprising:
a chamber in the housing; and
a trap opening in the housing for accessing the chamber;
wherein the trigger comprises a sensor positioned in the chamber or the trap opening for detecting the vermin;
wherein the actuator is connected to the locking lever for rotating the locking lever in response to the sensor detecting the vermin.

4. The vermin trap according to claim 3, wherein the catcher comprises a door pivotable in the trap opening for trapping the vermin in the chamber.

5. The vermin trap according to claim 3, wherein the catcher comprises a snare with a snare opening extending around the trap opening in the housing, capable of reciprocating relative to the housing and trapping the vermin.

6. The vermin trap according to claim 5, wherein the housing includes a housing base for mounting on a surface, and a front wall at an acute angle to the housing base;
wherein the trap opening is accessible from the front wall, whereby dead vermin fall away from the trap opening enabling reuse.

7. The vermin trap according to claim 1, wherein the striker includes a striker arm pivotable on the housing, and the striker bar for engaging the latching lever;
wherein the catcher is mounted on an end of the striker arm configured to be forced from the set position to the sprung position for trapping an animal.

8. The vermin trap according to claim 7, wherein the latching lever comprises a fork bolt lever including:
a lower tine configured to engage the striker bar, thereby rotating the latching lever against the spring bias, as the striker arm and the latching lever are rotated into the set position, and
an upper tine for holding the striker bar in the set position.

9. The vermin trap according to claim 3, wherein the trigger comprises a force applicator, one end of which extends into the chamber, and another end of which is connected to the locking lever.

10. The vermin trap according to claim 1, further comprising:
a reset arm for moving the striker and the catcher into the set position;
a motor for rotating the reset arm; and
a trap controller configured to activate the motor for resetting the reset arm.

11. The vermin trap according to claim 10, wherein the reset arm extends through the striker when in the sprung position, and is configured to reposition the striker bar back into the latch.

12. The vermin trap according to claim 10, further comprising a receiver;
wherein the trap controller is also configured to receive a signal from a user for activating the motor to reset the reset arm.

13. The vermin trap according to claim 1, further comprising a transmitter for transmitting a signal to a user that the trap has been sprung.

14. The vermin trap according to claim 1, further comprising:
a camera for capturing a still image or a moving image of a creature in or around the vermin trap;
a trap controller configured to determine whether the creature is considered vermin using smart recognition on the still image or the moving image of the creature.

15. The vermin trap according to claim 14, wherein the trap controller is configured to activate the trigger when the creature is considered vermin.

16. The vermin trap according to claim 15, further comprising a boundary crossing detector configured to determine when the creature has entered the trap;
wherein the trap controller is configured to activate the trigger when the creature is considered vermin, and when the boundary crossing detector determines the creature has entered the trap.

17. The vermin trap according to claim 14, wherein the trap controller is configured to enable the trigger to be activated by the creature when the creature is considered vermin, and disable the trigger when the creature is not considered vermin.

18. The vermin trap according to claim 14, further comprising a proximity sensor for activating the camera when a creature enters a predetermine zone in or around the vermin trap.

19. The vermin trap according to claim 18, wherein the proximity sensor is configured to activate the camera when the creature enters the trap.

20. The vermin trap according to claim 14, further comprising a transmitter; wherein the trap controller is also configured to transmit the still image or the moving image of the creature to a user via the transmitter.

21. The vermin trap according to claim 14, further comprising a visual or audible alarm configured to be activated by the trap controller for warning the creature away from the trap when the trap controller determines that the creature is not considered vermin.

22. The vermin trap according to claim 14, wherein the trap controller is configured to update a database of creatures considered vermin and/or creatures not considered vermin using the still images or the moving images of the creatures over time.
